(19) United States
(12) Patent Application Publication
(10) Pub. No.: US 2002/0085272 A1
(43) Pub. Date: Jul. 4, 2002

(54) Rigid video-endoscope system

(75) Inventors: Makoto Tomioka, Tokyo (JP); Hiroshi Tsuyuki, Tokyo (JP)

Correspondence Address: ARMSTRONG,WESTERMAN & HATTORI, LLP, 1725 K STREET, NW., SUITE 1000, WASHINGTON, DC, 20006, US

(73) Assignee: OLYMPUS OPTICAL CO., LTD., Tokyo (JP)

(21) Appl. No.: 09/893,677

(22) Filed: Jun. 29, 2001

(30) Foreign Application Priority Data
Jun. 11, 2001 (JP) 2001-175203

(51) Int. Cl. A62B 1/04

(52) U.S. Cl. 359/362; 348/65

(57) ABSTRACT

A rigid video-endoscope system includes a front-end insertion section and a camera head. The rigid video-endoscope system has, in order from an object side thereof and in the direction of the front-end insertion section to the camera head, an objective optical system, a relay optical system, an imaging optical system and a solid-state image sensor, wherein the front-end insertion section and camera head are detachable in the region of said relay optical system.

### FIELD OF THE INVENTION

The present invention relates to a video endoscope widely used in the medical field, and more particularly, to a rigid video-endoscope system used in the surgical field.

### BACKGROUND OF THE INVENTION

Recently, a minimum invasive technique using an endoscope has come into wide use in the field of medical surgery. The minimum invasive technique provides various operative treatments by use of dedicated surgical instruments as observing an affected area with an endoscope, and can advantageously achieve lower postoperative damage in the body, shorter hospitalization and reduced relative cost, compared with celiotomy. Thus, such a technique is projected to have a continuous growth as a dominant medical technology capable of providing fewer burdens both to patients and medical organizations.

Generally, a video rigid-endoscope system is employed in actual applications of the minimum invasive technique using an endoscope, and an operator (medical doctor) performs a surgical operation as observing images displayed on a TV monitor screen. The video endoscope system includes;

(1) a type in which an external camera having a solid-state image sensor therewithin is attached to an ocular section of an rigid endoscope used for macroscopic observation, and optical images obtained from the rigid endoscope are picked up through the external camera (an external camera type), (2) a type in which a small-size, solid-state image sensor is provided inside a front-end section of a rigid endoscope, and TV images are picked up directly at the front-end section of the rigid endoscope (a front-end CCD type).

The front-end CCD type has the following disadvantages.

a) Since the solid-state image sensor is required to be accommodated within the very thin rigid endoscope typically having an outer diameter of 6 mm or less, the imaging surface of the device is inevitably designed to have a very small area which restricts the number of pixels to be provided therein. Thus, it is difficult to provide images with high image quality.

b) The front-end CCD type rigid endoscope is expensive. In addition, a plurality of endoscopes having different viewing directions is usually needed. This will impose an excessive expenditure for completing a sufficient system on medical organizations.

c) The rigid endoscope can be damaged by getting contact with a surgical instrument for use therewith depending on operative regions. The resulting breakage of the expensive front-end CCD type rigid endoscope will impose a heavy expenditure on medical organizations.

Thus, the external camera type is generally suitable for use in the minimum invasive technique. On the other hand, the minimum invasive technique using the conventional external camera type has been involved in the following problems, which will be described with reference to FIGS. 1 and 2.

FIG. 2 is a schematic view showing an optical system of a conventional external camera type video rigid-endoscope. This system comprises a rigid endoscope 501 and an external camera 502 detachably mounted on the ocular section of the rigid endoscope 501. The rigid endoscope 501 includes, in order from its distal end section to be inserted into the body or the like, an objective lens 1, a relay lens system having a first relay lens 2-1, a second relay lens 2-2 and a third relay lens 2-3, a view field mask 3, and an ocular lens 4. The number of the relay lens is not limited to three, but is generally designed in odd number to provide an erect image. The external camera 502 includes an image pickup lens 5 and a solid-state image sensor 6. A one-dot chain line O indicates an optical axis.

The objective lens 1 forms an image Q1 of an object Q, and then the image Q1 is sequentially transmitted through relay lenses 2-1, 2-2 and 2-3 to form an image Q4 of the object at an aperture of the view field mask 3. The image Q4 is projected on the solid-state image sensor through the view field mask 3, the ocular lens 4 and the imaging lens 5, and the resulting image having an outer edge defined by the view field mask 3 is observed by a TV monitor. FIG. 1 shows such a state in which the object image (while zone) having the outer edge trimmed by the circular aperture of the view field mask is displayed on the monitor screen.

As shown in FIG. 1, the object image is out of the center of a monitor screen and is partially dropped out. This arises from the following factors. In the rigid endoscope, the aperture center of the view field 3 can be deviated from the optical axis O due to an assembling or manufacturing error of the view field mask. In the external camera, the imaging lens 5 and solid-state image sensor 6 can also be decentered each other. Further, when the external camera is attached to the rigid endoscope, a slight inclination can be caused therebetween. Consequently, the optical axis of the rigid endoscope does not come perfectly into line with that of the external camera. These deviations and inclination are minor. However, on the process of magnifying and imaging an object image transmitted through the endoscope having a very small diameter of several millimeters at utmost, such a deviance is also magnified and thereby the object image is displayed with an undesirable displacement on the monitor screen. While each of the rigid endoscope and the external camera can be individually adjusted during their assembling processes, it is difficult to perfectly adjust as the entire endoscope system because the view field mask and the solid-state image sensor are located separately in the rigid endoscope and the external camera, respectively. Thus, the displacement of the object image remains undesirably.

The displacement of the object image on the monitor screen caused by the above factors provides a degraded appearance. Further, if the view field is partially dropped out, it needs to spend time finding out the position of a surgical instrument such as a shaver. This undesirably raises the possibility that the surgical instrument contacts with and damages the front-end section of the rigid endoscope.

Further, in the low inversion technique, a rigid endoscope having an oblique-viewing direction may be attached to an external camera, and may be rotated to observe viscera in all directions of a 360-degree. In this case, if the view field has some displacement, the view field is undesirably moved on a monitor screen when rotating the rigid endoscope, resulting in significantly deteriorated visibility.

### SUMMARY OF THE INVENTION

In view of the above problems of the conventional external camera type rigid video-endoscope system, it is therefore an object of the present invention to provide an improved rigid video-endoscope system capable of eliminating any undesirable displacement of a view field mask displayed on a TV monitor.

In order to achieve the above object, according to the present invention, there is provided a rigid video-endoscope system including a front-end insertion section and a camera head, said rigid video-endoscope system comprising: in order from an object side thereof and in the direction of said front-end insertion section to said camera head, an objective optical system, a relay optical system, an imaging optical system and a solid-state image sensor, wherein said front-end insertion section and camera head are detachable in the region of said relay optical system.

The object of the present invention is also achieved by providing a rigid video-endoscope system wherein said camera head includes a part of said relay optical system, said imaging optical system and said solid-state imaging sensor, said camera head further including a view field mask, wherein said view field mask, said imaging optical system and said solid-state imaging sensor are constructed to be integrally moved in an focusing operation.

The object of the present invention is also achieved by providing a rigid video-endoscope system further comprising a mask adjusting device for adjusting the position of said view field mask vertically with respect to an optical axis to allow said view field mask to be focused into an image on the center of said solid-state image sensor without decentering from said center when said view field mask is focused into an image on said solid-state image sensor through said imaging optical system.

The object of the present invention is also achieved by providing a rigid video-endoscope further comprising a solid-state image sensor adjusting device for adjusting the position of said solid-state image sensor vertically with respect to an optical axis to allow said view field mask to be focused into an image on the center of said solid-state image sensor without decentering from said center when said view field mask is focused into an image on said solid-state image sensor through said imaging optical system.

The object of the present invention is also achieved by providing a rigid video-endoscope system wherein said imaging optical system includes a cemented lens having at least positive power, two positive lenses and a single negative lens.

The object of the present invention is also achieved by providing a rigid video-endoscope system wherein said camera head includes a part of said relay optical system, said imaging optical system and said solid-state imaging sensor, said camera head further including a view field mask, wherein said part of said relay optical system is constructed to be moved in an focusing operation.

The object of the present invention is also achieved by providing a rigid video-endoscope system further comprising a mask adjusting device for adjusting the position of said view field mask vertically with respect to an optical axis to allow said view field mask to be focused into an image on the center of said solid-state image sensor without decentering from said center when said view field mask is focused into an image on said solid-state image sensor through said imaging optical system.

The object of the present invention is also achieved by providing a rigid video-endoscope system further comprising a solid-state image sensor adjusting device for adjusting the position of said solid-state image sensor vertically with respect to an optical axis to allow said view field mask to be focused into an image on the center of said solid-state image sensor without decentering from said center when said view field mask is focused into an image on said solid-state image sensor through said imaging optical system.

The object of the present invention is also achieved by providing a rigid video-endoscope system wherein said imaging optical system includes a cemented lens having at least positive power, two positive lenses and a single negative lens.

The object of the present invention is also achieved by providing a rigid video-endoscope system wherein said camera head includes a part of said relay optical system, said imaging optical system and said solid-state imaging sensor, said camera head further including a view field mask, and said imaging optical system including a front lens group and a rear lens group, wherein said view field mask and said front lens group are constructed to be integrally moved in an focusing operation.

The object of the present invention is also achieved by providing a rigid video-endoscope system wherein said view field mask is located substantially at the front focal point of said front lens group.

The object of the present invention is also achieved by providing a rigid video-endoscope system further comprising a mask adjusting device for adjusting the position of said view field mask vertically with respect to an optical axis to allow said view field mask to be focused into an image on the center of said solid-state image sensor without decentering from said center when said view field mask is focused into an image on said solid-state image sensor through said imaging optical system.

The object of the present invention is also achieved by providing a rigid video-endoscope system further comprising a solid-state image sensor adjusting device for adjusting the position of said solid-state image sensor vertically with respect to an optical axis to allow said view field mask to be focused into an image on the center of said solid-state image sensor without decentering from said center when said view field mask is focused into an image on said solid-state image sensor through said imaging optical system.

The object of the present invention is also achieved by providing a rigid video-endoscope system wherein said imaging optical system includes a cemented lens having at least positive power, two positive lenses and a single negative lens.

The object of the present invention is also achieved by providing a rigid video-endoscope system wherein said front-end insertion section has an outer diameter of φ6 or less.

The object of the present invention is also achieved by providing a rigid video-endoscope system wherein said front-end insertion section is rotatable with respect to said camera head.

The object of the present invention is also achieved by providing a rigid video-endoscope system wherein a variety of said front-end insertion sections are selectively replaceable to said camera head.

The object of the present invention is also achieved by providing a rigid video-endoscope system wherein light beam is substantially parallelized between said front-end insertion section and said camera head.

Other features and advantages of the present invention will be apparent from the accompanying drawings and from the detailed description.

### BRIEF DESCRIPTION OF THE DRAWINGS

FIG. 1 is a view showing a view field mask displayed on a TV monitor.

FIG. 2 is a schematic view showing an optical system of a conventional external camera type video rigid endoscope.

FIG. 3 is a schematic view showing a basic construction of the present invention.

FIG. 4 is a schematic view showing a first focusing scheme.

FIG. 5 is a schematic view showing a second focusing scheme.

FIG. 6 is a schematic view showing a third focusing scheme.

FIG. 7 is a schematic view showing an optical system concerning a first numerical example..

FIG. 8 (A) is a schematic view showing a 30-degree oblique-viewing optical system.

FIG. 8 (B) is a schematic view showing a 70-degree oblique-viewing optical system.

FIG. 9 is a schematic view showing each optical axis of a front-end insertion section and a camera head.

FIG. 10 is a schematic view of an example in which the first numerical example is applied to the first focusing scheme.

FIG. 11 is a schematic view of an example in which the first numerical example is applied to the second focusing scheme.

FIG. 12 is a diagram of aberrations before and after movement in the second focusing scheme.

FIG. 13 is a schematic view of an example in which a second numerical example is applied to the third focusing scheme.

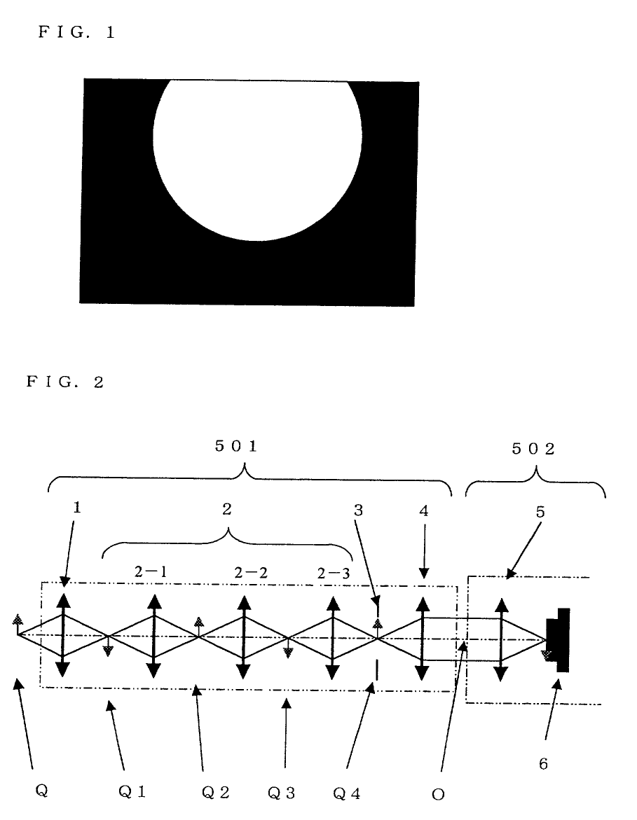

### DESCRIPTION OF THE PREFERED EMBODIMENT

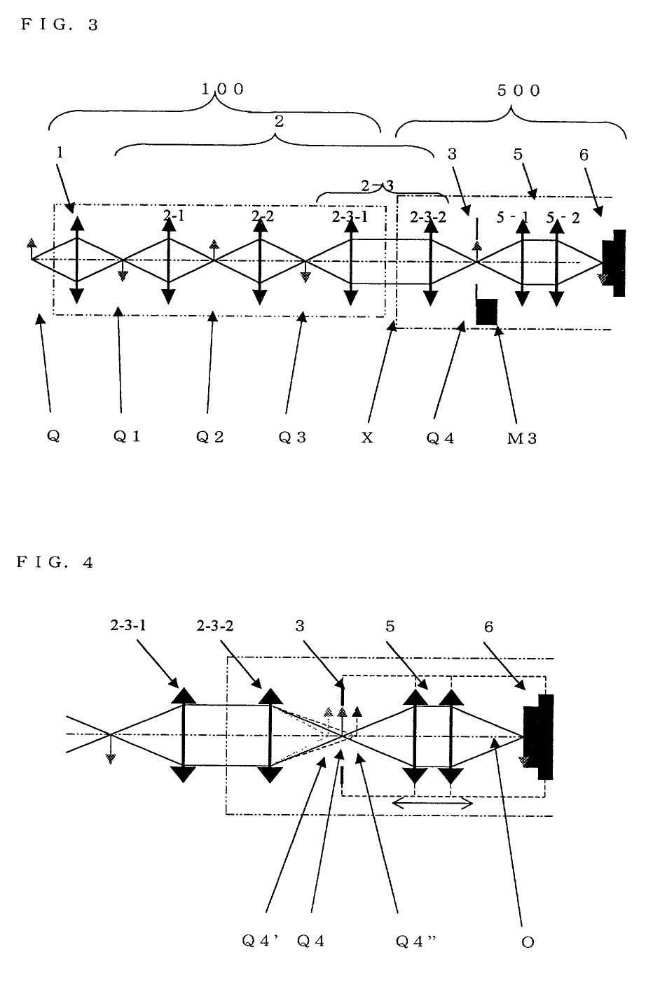

FIG. 3 shows a basic construction of the present invention. In the following description, the same elements in function as those of the conventional system shown in FIG. 2 are identified by the same reference numerals and their detailed description will be omitted.

As shown in FIG. 3, a rigid video-endoscope system of the present invention comprises a front-end insertion section 100 and a camera head 500 which are detachable from each other. The front-end insertion section 100 comprises, in order from its distal end side or an object side, an objective lens 1, a first relay lens 2-1, a second relay lens 2-2, and a front half section 2-3-1 of a third relay lens 2-3, therewithin. The camera head 500 comprises a rear half section 2-3-2 of the third relay lens 2-3, an imaging lens 5 including two lens sections 5-1, 5-2, a view field mask 3 disposed between the rear half section 2-3-2 and the imaging lens, and a solid-state image sensor 6, therewithin. While each lens is simply represented by an arrow, these maybe composed of one or plurality of lenses as is apparent from numerical examples to be described later. The number of the relay lenses and the number of lenses included in the imaging lens are intended to show one example and it is apparent not to be limited to such numbers.

In this construction, a detachable position X is provided at the center of the third relay lens 2-3 to detachably mount the camera head 500 on the front-end insertion section 100. However, a segment in the range of a first relay lens 2-1 to the third relay lens 2-3 can optically function as a relay optical system 2. The objective lens 1 forms an image Q1 of an object Q, and the object image Q1 is transmitted sequentially to each position of an image Q2 and an image Q3 through relay lenses 2-1, 2-2. The image Q3 is focused as an image Q4 at an aperture of the view field mask 3 in the camera head 500 through the relay lens 2-3. The front half section 2-3-1 and rear half section 2-3-2 of the relay lens 2-3 are positioned to parallelize a light beam therebetween, and the view field mask 3 is positioned at a posterior focal point of the rear half section 2-3-2. That is, the third relay lens 2-3 is formed substantially as a telecentric optical system to provide a parallelized light beam at a connection portion of the front-end insertion section and the camera head.

The view field mask 3 is positioned at a conjugate point of the solid state image sensor 6 with respect to the imaging lens 5 to clearly project the image Q1 with the view field mask 3 on the solid-state image sensor 6 through the imaging lens 5.

The camera head 500 includes a mask adjusting device M3 capable of adjusting the position of the view field mask 3 vertically to the optical axis of the imaging lens 5 during an assembly process of the camera head 500. Thus, the view field mask can be adjusted to locate an image at a central position of a TV monitor all the time. This prevents view field from displacing or partially dropping out on the monitor screen so that the problem involved in the conventional rigid video-endoscope system can be solved. Further, if the front-end insertion section is rotated, the view field mask 3 can keep its position with respect to the solid-state image sensor 6. Thus, even if the front-end insertion section includes an oblique-viewing objective lens and this front-end insertion section is rotated, the position of the view field mask is never moved.

The front-end insertion section is replaceable. Thus, a desirable viewing direction can be selected by preparing a plurality of front-end insertion sections each having a different viewing direction adapted to a particular surgical technique or operator and selectively attaching a suitable front-end insertion section.

As described above, even if the front-end insertion section is replaced or rotated, the position of the view field mask is never moved so that the position of the image displayed on the TV monitor can be stabilized all the time.

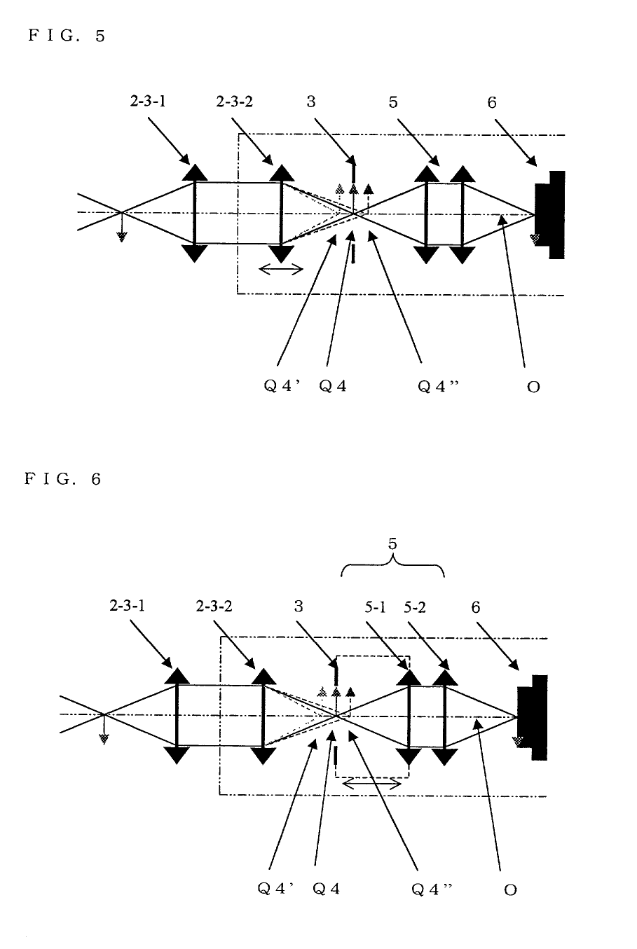

The rigid video-endoscope system according to the present invention is arranged to repeat image transmission plural times in the relay lens system 2. This can cause a frontward/rearward displacement in the position of the image Q4 focused on the view field mask 3, i.e. an image position displacement. The front-end insertion section of the rigid video-endoscope system according to the present invention is replaceable and practically replaced. Thus, if the camera head is adjusted for the image position displacement of only one front-end insertion section, the image position displacement is caused again when replaced with another one. In order to avoid this problem, the rigid video-endoscope system according to the present invention provides a focusing function to the camera head. This will now be described with reference to FIGS. 4 to 6.

FIG. 4 is a schematic view showing a first focusing scheme. In this figure, Q4 indicates an image formed at a position as an object image ought to be formed, Q4′ indicating an image formed at a position which is displaced frontward with respect to the image Q4, and Q4″ indicating an image formed at a position which is displaced rearward with respect to the image Q4. In FIG. 4, the view field mask 3, the imaging lens 5 and the solid-state image sensor 6 are connected to each other by a broken line. This means that these elements are mechanically coupled with each other not to mutually move. In addition, these elements are constructed to be able to integrally move frontward and rearward along the optical axis O as shown by the arrow in FIG. 4.

When operating the focusing function, the view field mask 3, the imaging lens 5 and the solid-state image sensor 6 are integrally moved. For example, when the image position is displaced to the position of Q4′, by moving the view field mask 3 to align the view field mask 3 with Q4′, the view field mask and object can be sharply displayed on the TV monitor. When the image position is displaced to the position of Q4″, the similar operation can be applied. In these operations, since the view field mask 3, the imaging lens 5 and the solid-state image sensor 6 are integrally moved, the image of the view field mask is located at the central position of the TV monitor all the time, and the size of the view field mask 3 on the TV monitor is not varied in conjunction with the focusing operation.

FIG. 5 is a schematic view showing a second focusing scheme. In this example, the rear half section 2-3-2 of the final relay lens 2-3 is constructed to be able to move along the optical axis as shown by the arrow in FIG. 5. When the image position is displaced frontward or rearward, i.e. to the position of Q4′ or Q4″, by moving the lens 2-3-2 to align the position of Q4′ or Q4″ with the position of the view field mask, the view field mask and object can be sharply displayed on the TV monitor. Since the light beam at the connection portion of the final relay lens 2-3 is arranged to be parallel rays, an imaging magnification is not varied even if the rear half section 2-3-2 of the relay lens 2-3 is moved, and thereby the size of the view field mask 3 on the TV monitor is not varied in conjunction with the focusing operation.

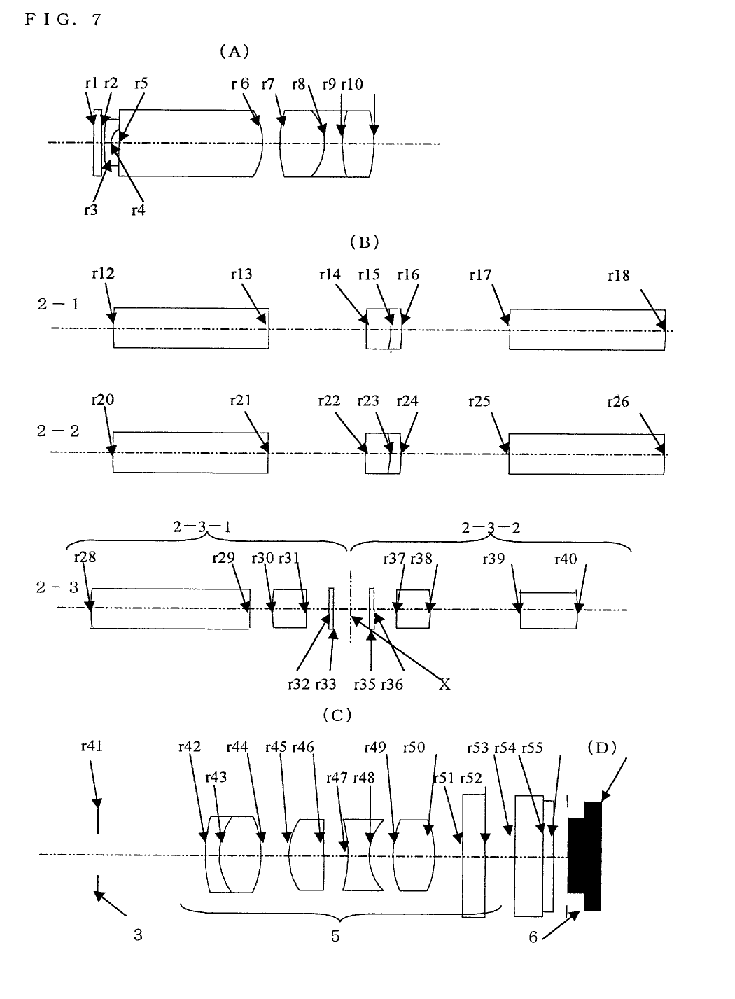

FIG. 6 is a schematic view showing a third focusing scheme. In this example, the physical relationship between the front half section 5-1 and rear half section of the imaging lens 5 is arranged to parallelize light beam therebetween. In addition, the view field mask 3 is positioned substantially at the anterior focal position of the front half section 5-1, and the solid-state image sensor 6 is positioned substantially at the posterior focal position of the rear half section 5-2. In FIG. 6, the view field mask 3 and the front half section 5-1 of the imaging lens 5 are connected to each other by a broken line. This means that these elements are mechanically coupled with each other not to mutually move. In addition, these elements are constructed to be able to integrally move frontward and rearward along the optical axis O as shown by the arrow in FIG. 6. As with the example of FIG. 4, by carrying out the focusing operation to align the view field mask 3 with the image position, the view field mask and object can be sharply displayed on the TV monitor.

In this example, the light beam is parallelized between the front half section 5-1 and rear half section of the imaging lens 5. Thus, during the focusing operation, the view field mask 3 is projected on the solid-state image sensor 6 with a constant magnification, and a sharp mask image can be observed on the TV monitor without any variance in size.

The focusing function can be obtained by moving the rear half section 5-2 of the imaging lens 5. Further, the focusing function can be obtained without the parallelized light beam between the front half section 5-1 and the rear half section 5-2. However, in this case, the feature of a constant imaging magnification cannot be obtained.

### First Numerical Example

An embodiment of the present invention will now be described in conjunction with each optical system of the embodiment. The data of the embodiment is shown as follows.

Object Distance = 10, Incident NA = 0.0056, Field Angle 98 degree,
Image Height = 1.205

| r1 = ∞ | d1 = 0.30 | n1 = 1.76820 | ν1 = 71.79 |
|---|---|---|---|
| r2 = ∞ | d2 = 0.10 | | |
| r3 = 6.544 | d3 = 0.25 | n3 = 1.78472 | ν3 = 25.68 |
| r4 = 0.639 | d4 = 0.30 | | |
| r5 = ∞ | d5 = 5.50 | n5 = 1.88300 | ν5 = 40.76 |
| r6 = −2.406 | d6 = 0.65 | | |
| r7 = 4.846 | d7 = 1.70 | n7 = 1.51633 | ν7 = 64.14 |
| r8 = −1.922 | d8 = 0.70 | n8 = 1.84666 | ν8 = 23.78 |
| r9 = 4.901 | d9 = 1.20 | n9 = 1.78590 | ν9 = 44.20 |
| r10 = −4.901 | d10 = 3.07 | | |
| r11 = ∞ | d11 = 5.00 Image position | | |
| r12 = 13.042 | d12 = 18.00 | n12 = 1.51633 | ν12 = 64.14 |
| r13 = ∞ | d13 = 11.31 | | |
| r14 = 18.882 | d14 = 2.86 | n14 = 1.51633 | ν14 = 64.14 |
| r15 = −4.323 | d15 = 1.24 | n15 = 1.64769 | ν15 = 33.79 |
| r16 = −9.439 | d16 = 12.51 | | |
| r17 = ∞ | d17 = 18.00 | | |
| r18 = −13.042 | d18 = 5.00 | n18 = 1.51633 | ν18 = 64.14 |
| r19 = ∞ | d19 = 5.00 image position | | |
| r20 = 13.042 | d20 = 18.00 | n20 = 1.51633 | ν20 = 64.14 |
| r21 = ∞ | d21 = 11.31 | | |
| r22 = 18.882 | d22 = 2.86 | n22 = 1.51633 | ν22 = 64.14 |
| r23 = −4.323 | d23 = 1.24 | n23 = 1.64769 | ν23 = 33.79 |
| r24 = −9.439 | d24 = 12.51 | | |
| r25 = ∞ | d25 = 18.00 | | |
| r26 = −13.042 | d26 = 5.00 | n26 = 1.51633 | ν26 = 64.14 |
| r27 = ∞ | d27 = 5.00 image position | | |
| r28 = 10.484 | d28 = 14.00 | n28 = 1.51633 | ν28 = 64.14 |
| r29 = ∞ | d29 = 2.00 | | |
| r30 = 9.216 | d30 = 3.00 | n30 = 1.51633 | ν30 = 64.14 |
| r31 = ∞ | d31 = 2.00 | | |
| r32 = ∞ | d32 = 0.40 | n32 = 1.76819 | ν32 = 71.79 |
| r33 = ∞ | d33 = 1.60 | | |
| r34 = ∞ | d34 = 1.60 detachable position | | |
| r35 = ∞ | d35 = 0.40 | n35 = 1.76819 | ν35 = 71.79 |
| r36 = ∞ | d36 = 2.00 | | |
| r37 = ∞ | d37 = 3.00 | n37 = 1.51633 | ν37 = 64.14 |
| r38 = −9.216 | d38 = 7.93 | | |
| r39 = ∞ | d39 = 5.00 | n39 = 1.51633 | ν39 = 64.14 |
| r40 = −10.484 | d40 = 7.93 | | |
| r41 = ∞ | d41 = 8.00 image view field position | | |
| r42 = 13.042 | d42 = 1.00 | n42 = 1.84666 | ν42 = 23.78 |
| r43 = 5.752 | d43 = 3.00 | n43 = 1.51633 | ν43 = 64.14 |
| r44 = −8.620 | d44 = 2.00 | | |
| r45 = 5.752 | d45 = 2.50 | n45 = 1.83481 | ν45 = 42.72 |
| r46 = ∞ | d46 = 1.75 | | |
| r47 = −12.113 | d47 = 1.50 | n47 = 1.78472 | ν47 = 25.68 |
| r48 = 4.502 | d48 = 1.70 | | |
| r49 = 8.502 | d49 = 3.00 | n49 = 1.72916 | ν49 = 54.68 |
| r50 = −8.502 | d50 = 2.00 | | |
| r51 = ∞ | d51 = 1.60 | n51 = 1.51400 | ν51 = 74.00 |
| r52 = ∞ | d52 = 2.11 | | |
| r53 = ∞ | d53 = 2.00 | n53 = 1.51633 | ν53 = 64.14 |
| r54 = ∞ | d54 = 2.00 | n54 = 1.51633 | ν54 = 64.14 |
| r55 = ∞ | d55 = 0.96 | | |

Where r1,r2—r55 is a radius of curvature for each lens, d1,d2—d55 is a thickness & lens distance, n1,n2—n54 is a refractive index of each lens,v1,v2—v54 is an Abbe number of each lens.

As shown in FIG. 7, this embodiment comprises, from a front-end insertion section toward a camera head, an objective optical system A, a relay optical system B, an imaging optical system C, and a solid-state image sensor D. The relay optical system B is shown over three rows, and each row corresponds, in order from upper row, to the first relay lens 2-1, the second relay lens 2-2, and the third relay lens 2-3.

Each relay lens in this embodiment has a diameter of φ2.8 mm which is set on the assumption that the front-end insertion section has an outer diameter of φ4 mm. Thus, an optical image is transmitted within the front-end insertion section by use of the relay optical system, and is picked up by the solid-state image sensor which is provided at a position affording enough outer diameter for having a sufficient number of pixels.

The rigid video-endoscope system according to this embodiment is constructed to be able to detach the front-end insertion section from the camera head. This detachable position is located within a final relay lens 2-3, and a front half section 2-3-1 and rear half section 2-3-2 of the final relay lens 2-3 are included in the front-end insertion section and the camera head, respectively. A view field mask 3 is positioned between the relay lens 2-3-2 in the camera head and the imaging optical system C, and the view field mask 3 defines a view field of an optical image which is formed through the objective optical system A and transmitted through the relay optical system B. Platy members indicated by r32-r33 and r35-r36 are a transparent window covering an outlet of the front-end insertion section and a transparent window covering a inlet of the camera head, respectively.

While the objective lens has an arrangement in which a negative lens (r3-r4) and a long positive lens (r5-r6) are aligned with each other inside a flat plate (r1-r2) in FIG. 7, a construction as shown in FIG. 8 may be practically used according to needs. FIG. 8 (A) shows an example comprising an oblique-viewing optical system having a viewing direction of 30 degrees with respect to the optical axis direction of the relay optical system or the longitudinal direction of the front-end insertion section. In this example, two prisms P1 and P2 and a positive lens are located after a negative lens. Light is reflected and changed in direction inside the prism P2 to provide a light having an oblique angle of 30 degrees and directing in the optical axis direction of the relay lens. Such an inflective optical path in prisms is optically equivalent to a long rod-like member. Thus, if the oblique-viewing optical system in FIG. 8 is used as a substitute for the objective lens (r3-r6) in FIG. 7, the same optical performance can be obtained as long as each length of both optical paths is the same. FIG. 8 (B) shows an example comprising an oblique-viewing optical system having a viewing direction of 70 degrees.

In the rigid video-optical system according to the above embodiment, the front-end insertion section is rotatable to the camera head. Thus, when an oblique-viewing front-end insertion section is employed, a wide range observation can be achieved by changing the viewing direction of the front-end insertion section with keeping the camera head in a certain direction.

The detachable portion in the final relay lens is arranged to provide substantially parallelized light beam. Thus, if an optical axis O′ of the front-end insertion section and an optical axis O″ of the camera head is vertically offset (FIG. 9), any image position displacement will not be caused at the view field mask.

The front-end insertion section is constructed to be detachable, and thereby various front-end insertion sections such as a front-end insertion section having a different viewing direction can be attached to one camera head. Thus, the image formed in the camera head is varied in position depending on the deviation of the front-end insertion section to be attached.

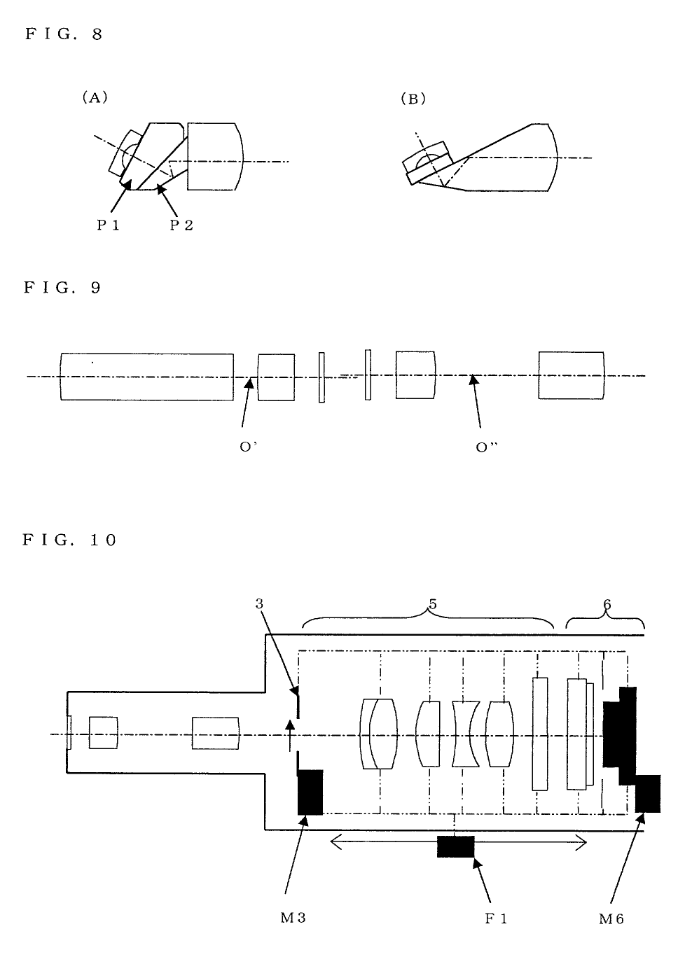

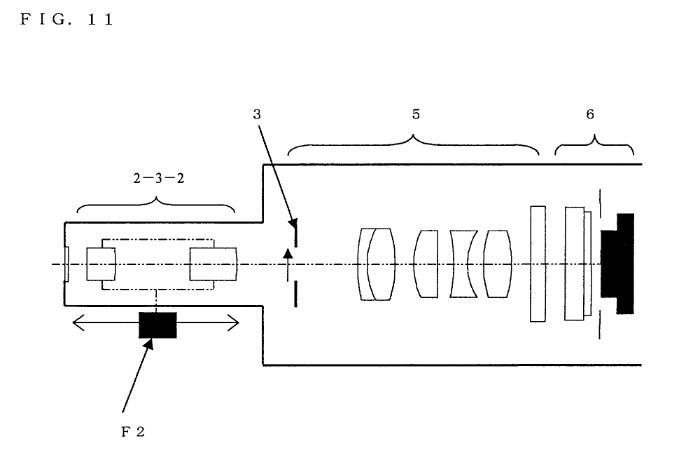

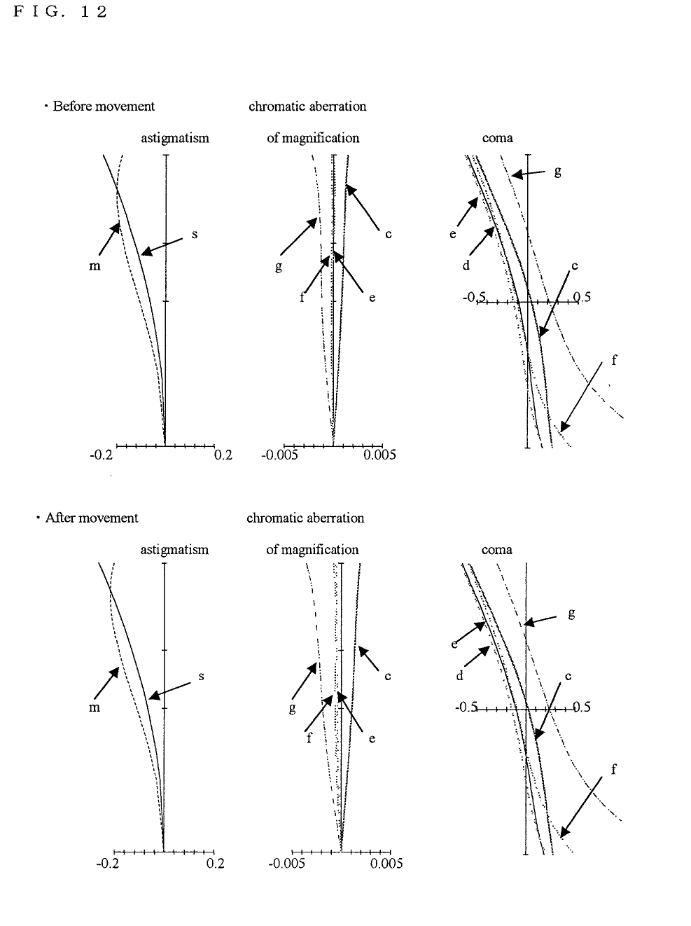

FIG. 10 is an explanatory view of an example in which the focusing scheme described based on FIG. 4 is applied to the above numerical example. As shown in the figure, the camera head includes a focusing device F1 for integrally moving the view field mask 3, the imaging optical system 5 and the solid-state image sensor 6, along the arrow. The view field mask 3, the imaging optical system 5 and the solid-state image sensor 6 are integrally moved based on the amount of the image position displacement arising from the difference of the front-end insertion section in order to provide an adequate image to the solid-state image sensor 6. Thus, the view field mask can be projected on the solid-state image sensor with best-focused state all the time. In addition, the view field mask is integrally moved so that the view field mask can be sharply focused all the time. Further, since the view field mask is kept in a constant position to the solid-state image sensor, the image of the view field mask is never varied in size during the focusing operation.

In order to project the view field mask on the solid-state image sensor without any offset, the position of the view field mask 3 is adjusted vertically to the optical axis by a mask adjusting device M3. For this position adjustment operation, a solid-state image sensor adjusting device M6 may be alternatively provided to adjusting the position of the solid-state image sensor vertically with respect to the optical axis.

In this example, the imaging optical system 5 comprises a cemented lens of r42-r44 and a triplet lenses composed of a positive lens, a negative lens and a positive lens, and an adequate correction for aberration is achieved only by the imaging optical system 5. Thus, the front-end insertion section can be independently corrected for aberration. This provides excellent system expandability.

FIG. 11 is an explanatory view of an example in which the focusing scheme described based on FIG. 5 is applied to the above numerical example. In this example, a focus device F2 is provided which moves the rear half 2-3-2 of the relay lens in the camera head to achieve the same effect. As described above, light beam is parallelized at the position where the front-end insertion portion is detached from the camera head. Thus, if the distance between the front half 2-3-1 of the relay lens in the front-end insertion section and the rear half 2-3-2 of the relay lens in the camera head is changed, both image magnification and on-axis aberration are never varied.

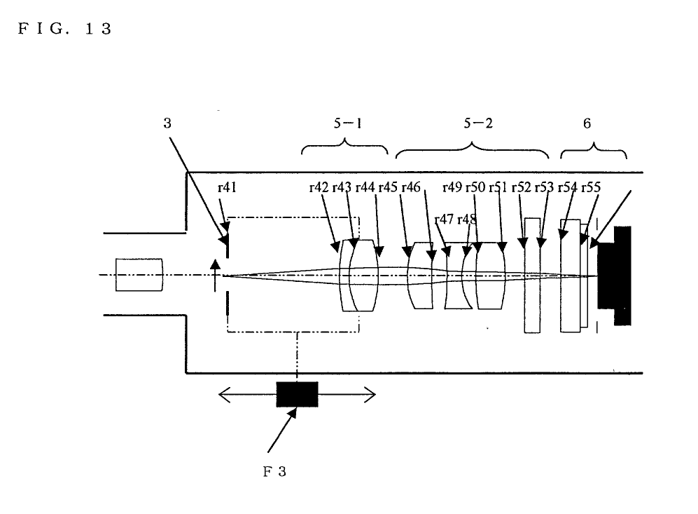

However, off-axis aberration can be slightly changed due to the variance of pupil position. FIG. 12 is a diagram of aberrations before and after the rear half 2-3-2 of the relay lens in the camera head is moved by 1 mm toward the solid-state image sensor. It can be proved that substantially no change of astigmatism, coma and chromatic aberration of magnification is exhibited. Thus, image quality is not practically degraded during the focusing operation. The symbols “m” and “s” in the astigmatism represent a meridional plane and a sagittal plane, respectively. The symbols “C”, “d”, “e”, “F” and “g” in the chromatic aberration of magnification and the coma represent Fraunhofer spectrum lines.

As described above, using the above focusing scheme allows only the image position to be aligned with the view field mask position without any change in image magnification and aberration. Further, the view field mask 3 can be projected on the solid-state image sensor 6 with best-focused state and without any offset so that the view field mask can be sharply focused into an image on the TV monitor without any decentering all the time.

### Second Numerical Example

The following numerical example shows only for lens data of the imaging optical-system in the camera head.

| r41 = ∞ | d41 = 8.50 Inage & view field mask | | |
|---|---|---|---|
| r42 = 8.916 | d42 = 1.00 | n42 = 1.84666 | ν42 = 23.78 |
| r43 = 5.020 | d43 = 3.00 | n43 = 1.51633 | ν43 = 64.14 |
| r44 = −6.881 | d44 = 3.00 | | |
| r45 = 5.452 | d45 = 2.50 | n45 = 1.83481 | ν45 = 42.72 |
| r46 = 13.681 | d46 = 1.45 | | |
| r47 = −9.535 | d47 = 1.50 | n47 = 1.78472 | ν47 = 25.68 |
| r48 = 5.414 | d48 = 0.99 | | |
| r49 = 17.330 | d49 = 3.00 | n49 = 1.72916 | ν49 = 54.68 |
| r50 = −5.301 | d50 = 2.00 | | |
| r51 = ∞ | d51 = 1.60 | n51 = 1.51400 | ν39 = 74.00 |
| r52 = ∞ | d52 = 2.11 | | |
| r53 = ∞ | d53 = 2.00 | n53 = 1.51633 | ν53 = 64.14 |
| r54 = ∞ | d54 = 2.00 | n54 = 1.51633 | ν53 = 64.14 |
| r55 = ∞ | d55 = 0.98 | | |

Front focal point of front group r42 r44:−8.507

Back focal point of rear group r45 r55: 0.976

Where r41,r42—r55 is a radius of curvature for each lens, d41,d42—d55 is a thickness & lens distance, n42,n43—n54 is a refractive index of each lens,v42,v43—v53 is an Abbe number of each lens.

In this imaging optical system, r42 to r44 and r45 to r55 correspond to a front lens group 5-1 and a rear lens group 5-2, respectively. Light beam is substantially parallelized between the front lens group 5-1 and the rear lens group 5-2. Further, the view field mask 3 and the solid-state image sensor 6 are located substantially at the front focal point of the front lens group 5-1 and the back focal point of the rear lens group 5-2, respectively.

FIG. 13 is an explanatory view of an example in which the focusing scheme described based on FIG. 6 is applied to this optical system. In this example, a focus device F3 is provided which integrally moves the view field mask 3 and the front lens group 5-1 to align the view field mask 3 with the image position. As described above, since light beam is substantially parallelized between the front lens group 5-1 and the rear lens group 5-2, an object image can be focused on the solid-state image sensor without any decentering in conjunction with the focusing operation. Further, the image magnification as entire imaging lens is never varied, and the image of the view field mask is never varied in size during the focusing operation. Furthermore, the variance in on-axis aberration is never caused and the variance in off-axis aberration is also very small. Thus, image quality is not practically degraded.

As described above, using the above focusing scheme allows only the image position to be aligned with the view field position without any change in image magnification and aberration. Further, the view field mask can be projected on the solid-state image sensor through the imaging lens with best-focused state and without any offset so that the view field mask can be sharply focused into an image on the TV monitor without any displacement all the time.

The invention has now been explained with reference to specific embodiments. Other embodiments will be apparent to those of ordinary skill in the art. Therefore, it is not intended that the invention be limited, except as indicated by the appended claims, which form a part of this invention description.

What is claimed is:

1. A rigid video-endoscope system including a front-end insertion section and a camera head, said rigid video-endoscope system comprising:
in order from an object side thereof and in the direction of said front-end insertion section to said camera head, an objective optical system, a relay optical system, an imaging optical system and a solid-state image sensor, wherein said front-end insertion section and camera head are detachable in the region of said relay optical system.

2. A rigid video-endoscope system as defined in claim 1, wherein said camera head includes a part of said relay optical system, said imaging optical system and said solid-state imaging sensor, said camera head further including a view field mask, wherein said view field mask, said imaging optical system and said solid-state imaging sensor are constructed to be integrally moved in an focusing operation.

3. A rigid video-endoscope system as defined in claim 2, further comprising a mask adjusting device for adjusting the position of said view field mask vertically with respect to an optical axis to allow said view field mask to be focused into an image on the center of said solid-state image sensor without decentering from said center when said view field mask is focused into an image on said solid-state image sensor through said imaging optical system.

4. A rigid video-endoscope system as defined in claim 2, further comprising a solid-state image sensor adjusting device for adjusting the position of said solid-state image sensor vertically with respect to an optical axis to allow said view field mask to be focused into an image on the center of said solid-state image sensor without decentering from said center when said view field mask is focused into an image on said solid-state image sensor through said imaging optical system.

5. A rigid video-endoscope system as defined in claim 2, wherein said imaging optical system includes at least a cemented lens having positive power, two positive lenses and a single negative lens.

6. A rigid video-endoscope system as defined in claim 1, wherein said camera head includes a part of said relay optical system, said imaging optical system and said solid-state imaging sensor, said camera head further including a view field mask, wherein said part of said relay optical system is constructed to be moved in an focusing operation.

7. A rigid video-endoscope system as defined in claim 6, further comprising a mask adjusting device for adjusting the position of said view field mask vertically with respect to an optical axis to allow said view field mask to be focused into an image on the center of said solid-state image sensor without decentering from said center when said view field mask is focused into an image on said solid-state image sensor through said imaging optical system.

8. A rigid video-endoscope system as defined in claim 6, further comprising a solid-state image sensor adjusting device for adjusting the position of said solid-state image sensor vertically with respect to an optical axis to allow said view field mask to be focused into an image on the center of said solid-state image sensor without decentering from said center when said view field mask is focused into an image on said solid-state image sensor through said imaging optical system.

9. A rigid video-endoscope system as defined in claim 6, wherein said imaging optical system includes at least a cemented lens having positive power, two positive lenses and a single negative lens.

10. A rigid video-endoscope system as defined in claim 1, wherein said camera head includes a part of said relay optical system, said imaging optical system and said solid-state imaging sensor, said camera head further including a view field mask, and said imaging optical system including a front lens group and a rear lens group, wherein said view field mask and said front lens group are constructed to be integrally moved in an focusing operation.

11. A rigid video-endoscope system as defined in claim 10, wherein said view field mask is located substantially at the front focal point of said front lens group.

12. A rigid video-endoscope system as defined in claim 10, which includes a mask adjusting device for adjusting the position of said view field mask vertically with respect to an optical axis to allow said view field mask to be focused into an image on the center of said solid-state image sensor without decentering from said center when said view field mask is focused into an image on said solid-state image sensor through said imaging optical system.

13. A rigid video-endoscope system as defined in claim 10, which includes a solid-state image sensor adjusting device for adjusting the position of said solid-state image sensor vertically with respect to an optical axis to allow said view field mask to be focused into an image on the center of said solid-state image sensor without decentering from said center when said view field mask is focused into an image on said solid-state image sensor through said imaging optical system.

14. A rigid video-endoscope system as defined in claim 10, wherein said imaging optical system includes at least a cemented lens having positive power, two positive lenses and a single negative lens.

15. A rigid video-endoscope system as defined in claim 1, wherein said front-end insertion section has an outer diameter of φ6 or less.

16. A rigid video-endoscope system as defined in claim 1, wherein said front-end insertion section is rotatable with respect to said camera head.

17. A rigid video-endoscope system as defined in claim 1, wherein a plurality of said front-end insertion sections are selectively replaceable to said camera head.

18. A rigid video-endoscope system as defined in claim 1, wherein light beam is substantially parallelized between said front-end insertion section and said camera head.
